(19) United States
(12) Patent Application Publication
(10) Pub. No.: US 2026/0214657 A1
(43) Pub. Date: Jul. 23, 2026

(54) TECHNIQUES FOR DATA STALL RECOVERY ASSOCIATED WITH BANDWIDTH PART SWITCHING

(71) Applicant: QUALCOMM Incorporated, San Diego, CA (US)

(72) Inventors: Ramesh Chandra CHIRALA, San Diego, CA (US); Sitaramanjaneyulu KANAMARLAPUDI, San Diego, CA (US); Sivaram Srivenkata PALAKODETY, San Diego, CA (US); Deepak WADHWA, San Diego, CA (US); Levent AYDIN, San Diego, CA (US); Naveen Kumar GOTTIPATI, Hyderabad (IN); Sanyyam KHANDELWAL, Kota (IN); Bhupesh Manoharlal UMATT, San Diego, CA (US); Vinesh Kisan KAVISKAR, San Diego, CA (US); Venkata Siva Prasad Rao GUDE, San Diego, CA (US)

(21) Appl. No.: 19/139,156

(22) PCT Filed: Feb. 7, 2024
(86) PCT No.: PCT/US2024/014800

§ 371 Date: Jun. 13, 2025

(30) Foreign Application Priority Data
Feb. 13, 2023 (IN) 202341009273

(51) Int. Cl. H04W 72/0457; H04W 72/0453; H04W 72/12; H04W 72/231

(52) U.S. Cl. CPC H04W 72/0457; H04W 72/0453; H04W 72/12; H04W 72/231

(57) ABSTRACT

Various aspects of the present disclosure generally relate to wireless communication. In some aspects, a user equipment (UE) may receive Network UE downlink control information indicating that an active bandwidth part (BWP) is to be switched from a first BWP to a second BWP. The UE may monitor the second BWP associated with receiving the downlink control information indicating that the active BWP is to be switched to the second BWP. The UE may detect a trigger event associated with activity associated with at least one of the first BWP or the second BWP. The UE may switch, in association with detecting the trigger event, the active BWP from the second BWP to the first BWP. The UE may monitor, in association with switching the active BWP, the first BWP. Numerous other aspects are described.

### CROSS-REFERENCE TO RELATED APPLICATION

This Patent Application claims priority to India Patent Application No. 202341009273, filed on Feb. 13, 2023, entitled “TECHNIQUES FOR DATA STALL RECOVERY ASSOCIATED WITH BANDWIDTH PART SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for data stall recovery associated with bandwidth part (BWP) switching.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving downlink control information indicating that an active bandwidth part (BWP) is to be switched from a first BWP to a second BWP. The method may include monitoring the second BWP associated with receiving the downlink control information indicating that the active BWP is to be switched to the second BWP. The method may include detecting a trigger event associated with activity associated with at least one of the first BWP or the second BWP. The method may include switching, in association with detecting the trigger event, the active BWP from the second BWP to the first BWP. The method may include monitoring, in association with switching the active BWP, the first BWP.

Some aspects described herein relate to a UE for wireless communication. The UE may include a memory and one or more processors coupled to the memory. The one or more processors may be configured to receive downlink control information indicating that an active BWP is to be switched from a first BWP to a second BWP. The one or more processors may be configured to monitor the second BWP associated with receiving the downlink control information indicating that the active BWP is to be switched to the second BWP. The one or more processors may be configured to detect a trigger event associated with activity associated with at least one of the first BWP or the second BWP. The one or more processors may be configured to switch, in association with detecting the trigger event, the active BWP from the second BWP to the first BWP. The one or more processors may be configured to monitor, in association with switching the active BWP, the first BWP.

Some aspects described herein relate to a non-transitory computer-readable medium that stores a set of instructions for wireless communication by a UE. The set of instructions, when executed by one or more processors of the UE, may cause the UE to receive downlink control information indicating that an active BWP is to be switched from a first BWP to a second BWP. The set of instructions, when executed by one or more processors of the UE, may cause the UE to monitor the second BWP associated with receiving the downlink control information indicating that the active BWP is to be switched to the second BWP. The set of instructions, when executed by one or more processors of the UE, may cause the UE to detect a trigger event associated with activity associated with at least one of the first BWP or the second BWP. The set of instructions, when executed by one or more processors of the UE, may cause the UE to switch, in association with detecting the trigger event, the active BWP from the second BWP to the first BWP. The set of instructions, when executed by one or more processors of the UE, may cause the UE to monitor, in association with switching the active BWP, the first BWP.

Some aspects described herein relate to an apparatus for wireless communication. The apparatus may include means for receiving downlink control information indicating that an active BWP is to be switched from a first BWP to a second BWP. The apparatus may include means for monitoring the second BWP associated with receiving the downlink control information indicating that the active BWP is to be switched to the second BWP. The apparatus may include means for detecting a trigger event associated with activity associated with at least one of the first BWP or the second BWP. The apparatus may include means for switching, in association with detecting the trigger event, the active BWP from the second BWP to the first BWP. The apparatus may include means for monitoring, in association with switching the active BWP, the first BWP.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with bandwidth adaptation, in accordance with the present disclosure.

FIG. 5 is a diagram of an example associated with a data stall recovery associated with bandwidth part (BWP) switching, in accordance with the present disclosure.

FIG. 6 is a diagram of an example associated with a data stall recovery associated with BWP switching, in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

In some cases, a user equipment (UE) and a network node may be unsynchronized (e.g., out-of-sync) as to which bandwidth part (BWP) is currently being monitored by the UE (e.g., which BWP is the active BWP for the UE). For example, the UE may receive and decode a communication indicating that an active BWP is to be switched from a BWP 1 to a BWP 2.

However, the communication may not be intended for the UE and the UE may mistakenly identify that the communication is intended for the UE. Therefore, the UE may switch the active BWP of the UE from the BWP 1 to the BWP 2. However, the network node may be unaware that the UE received and decoded the communication (and switched the active BWP). As another example, the UE may prioritize other procedures or operations that cause the UE to miss or discard an active BWP switch indication (e.g., downlink control information (DCI)). As a result, the UE may not receive or decode DCI indicating a BWP switch and/or may not receive or decode retransmission of the DCI. As a result, the UE may remain on a previous active BWP while the network node may switch the active BWP for the UE to a new active BWP, resulting in the UE and the network node being out-of-sync.

As a result, the UE may not receive scheduling grants, control information, and/or data that is transmitted by the network node via the BWP 1. For example, the UE may have uplink data to transmit (e.g., in a buffer of the UE). However, because the UE may not receive a scheduling grant via the active BWP being monitored by the UE (e.g., the BWP 2), the UE may be unable to transmit the data. As a result, the data may be discarded and/or lost by the UE due to the expiration of one or more timers (e.g., a packet data convergence protocol (PDCP) discard timer, a packet delay budget, or another timer). The expiration of the one or more timers may occur before an expiration of an inactivity timer associated with the BWP 2. For example, the UE may experience a data stall because of the mismatch between the active BWP that the network node associates with the UE (e.g., the BWP 1) and the active BWP being monitored by the UE (e.g., the BWP 2). This may result in lost data, increased latency, and reduced performance of the UE, among other examples. For example, in some cases, if a UE detects a data stall (e.g., due to lost data, as described above), the UE may perform one or more operations to recover the data stall, such as resetting a modem of the UE, among other examples, that increase latency, consume power of the UE, and/or result in a poor user experience, among other examples.

Some techniques and apparatuses described herein enable a quick and efficient data stall recovery associated with BWP switching. For example, a UE may be enabled to detect (e.g., autonomously) that the UE and a network node are out-of-sync with respect to the active BWP for the UE. The UE may perform one or more actions to cause the UE and the network node to be re-synchronized with respect to the active BWP of the UE. For example, the UE may receive, and a network node may transmit, an indication that an active BWP is to be switched from a first BWP to a second BWP (e.g., the indication may not actually be intended for the UE). The UE may switch the active BWP for the UE to the second BWP and may monitor the second BWP. The UE may detect a trigger event associated with activity associated with at least one of the first BWP or the second BWP. For example, the UE may autonomously detect that the second BWP should not be the active BWP for the UE. The UE may switch the active BWP from the second BWP to the first BWP (e.g., the previous active BWP before switching the active BWP to the second BWP) based on, in association with, or responsive to, detecting the trigger event. The UE may monitor the first BWP and/or receive one or more communications via the first BWP.

As a result, the UE is enabled to quickly detect that the UE has incorrectly switched the active BWP. By switching the active BWP back to the previous BWP (e.g., that was the active BWP) before switching the active BWP to the second BWP, the UE may quickly recover and/or switch to the correct active BWP for the UE, thereby ensuring that the UE and the network node are quickly re-synchronized with respect to the active BWP of the UE. This improves a likelihood that the UE is able to receive scheduling grants via the active BWP being monitored by the UE, thereby enabling the UE to transmit and/or receive data. Additionally, a likelihood that data is discarded and/or lost by the UE due to the switch to the incorrect active BWP is reduced (e.g., a PDCP discard timer, a packet delay budget, or another timer may not expire before the UE switches back to the correct active BWP as described in more detail elsewhere herein). For example, a likelihood that the UE experiences a data stall because of the mismatch between the active BWP that the network node associates with the UE (e.g., the BWP 1) and the active BWP being monitored by the UE (e.g., the BWP 2) is reduced. This reduces a likelihood of lost data, reduces latency, and/or improves performance of the UE, among other examples, in scenarios where the UE incorrectly switches the active BWP because of a reception of DCI indicating the switch (e.g., where the DCI is not actually intended for the UE).

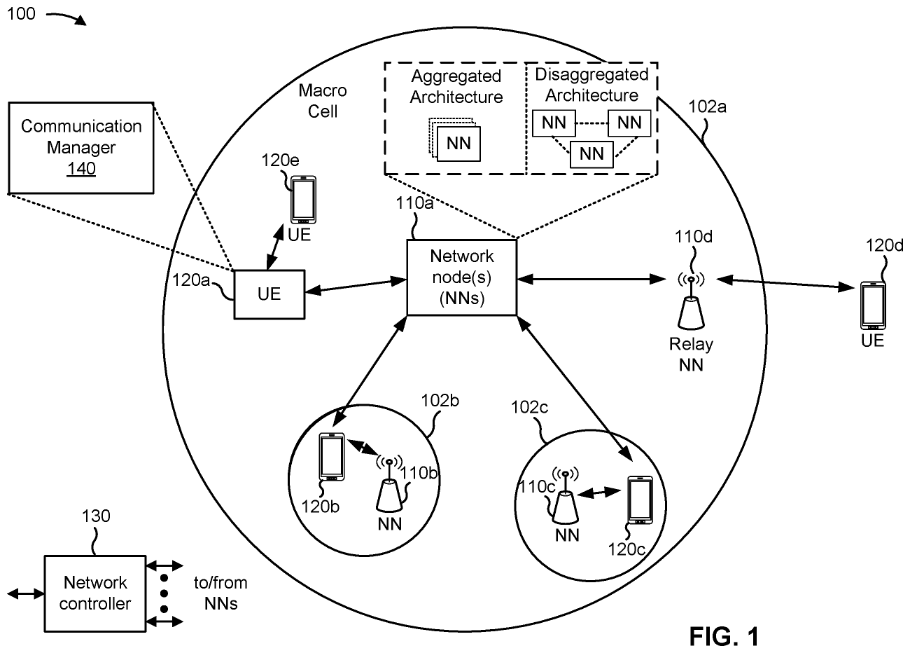

FIG. 1 is a diagram illustrating an example of a wireless network 100, in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive downlink control information indicating that an active BWP is to be switched from a first BWP to a second BWP; monitor the second BWP associated with receiving the downlink control information indicating that the active BWP is to be switched to the second BWP; detect a trigger event associated with activity associated with at least one of the first BWP or the second BWP; switch, in association with detecting the trigger event, the active BWP from the second BWP to the first BWP; and monitor, in association with switching the active BWP, the first BWP. Additionally, or alternatively, the communication manager 140 may perform one or more other operations described herein.

As indicated above, FIG. 1 is provided as an example. Other examples may differ from what is described with regard to FIG. 1.

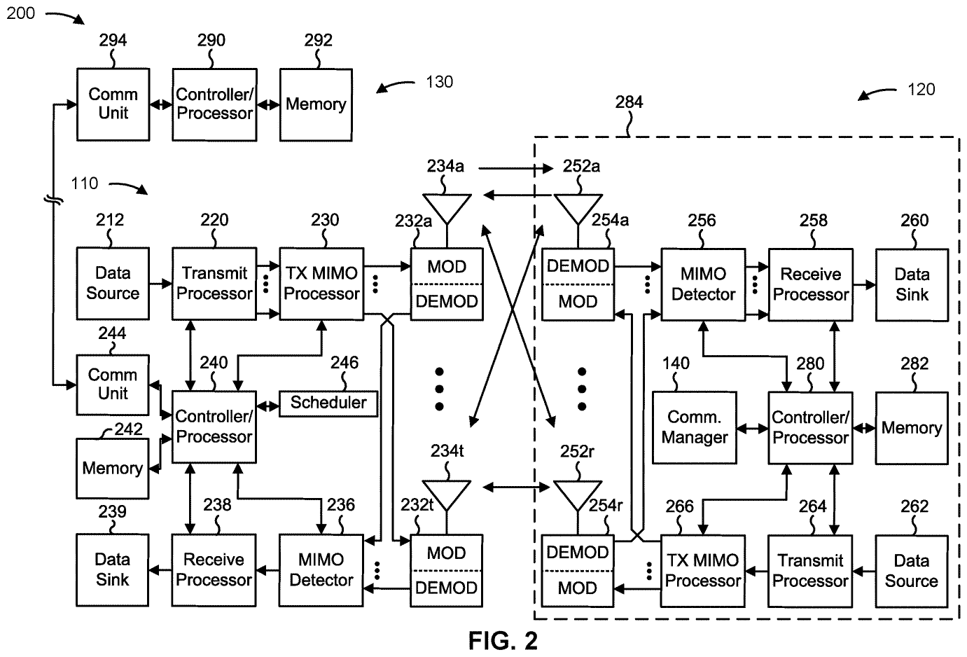

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

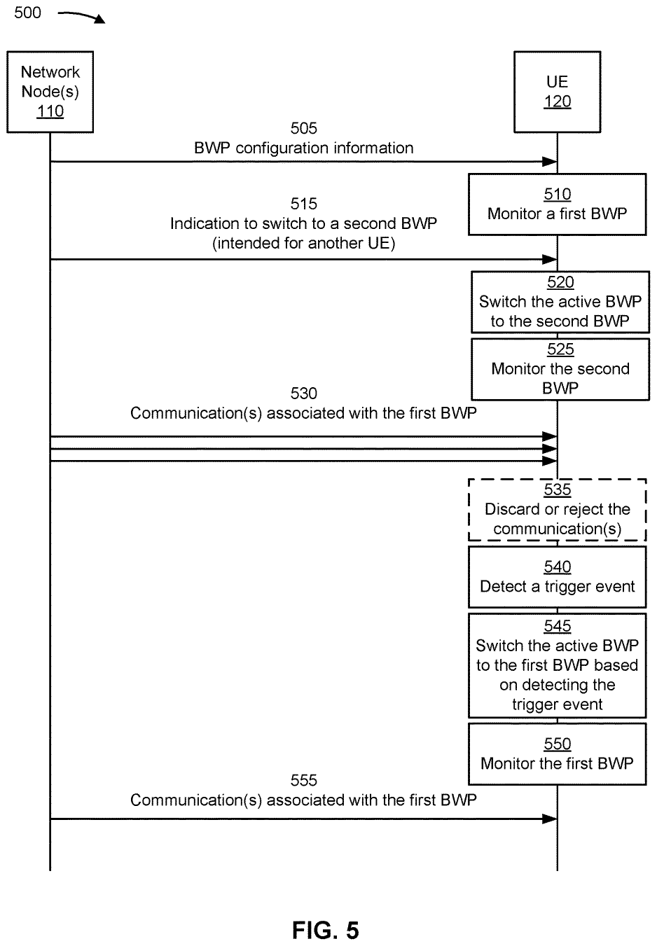

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 5-8).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 5-8).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

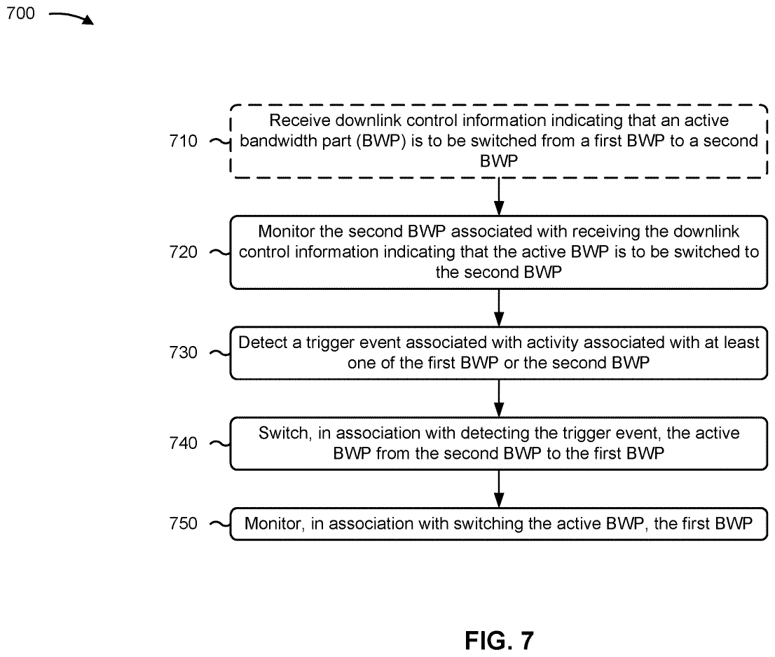

The controller/processor 240 of the network node 110, the controller/processor 280 of the UE 120, or any other component(s) of FIG. 2 may perform one or more techniques associated with data stall recovery associated with BWP switching, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving downlink control information indicating that an active BWP is to be switched from a first BWP to a second BWP; means for monitoring the second BWP associated with receiving the downlink control information indicating that the active BWP is to be switched to the second BWP; means for detecting a trigger event associated with activity associated with at least one of the first BWP or the second BWP; means for switching, in association with detecting the trigger event, the active BWP from the second BWP to the first BWP; and/or means for monitoring, in association with switching the active BWP, the first BWP. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, the term “base station”, “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a CU, a DU, an RU, a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the network node 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

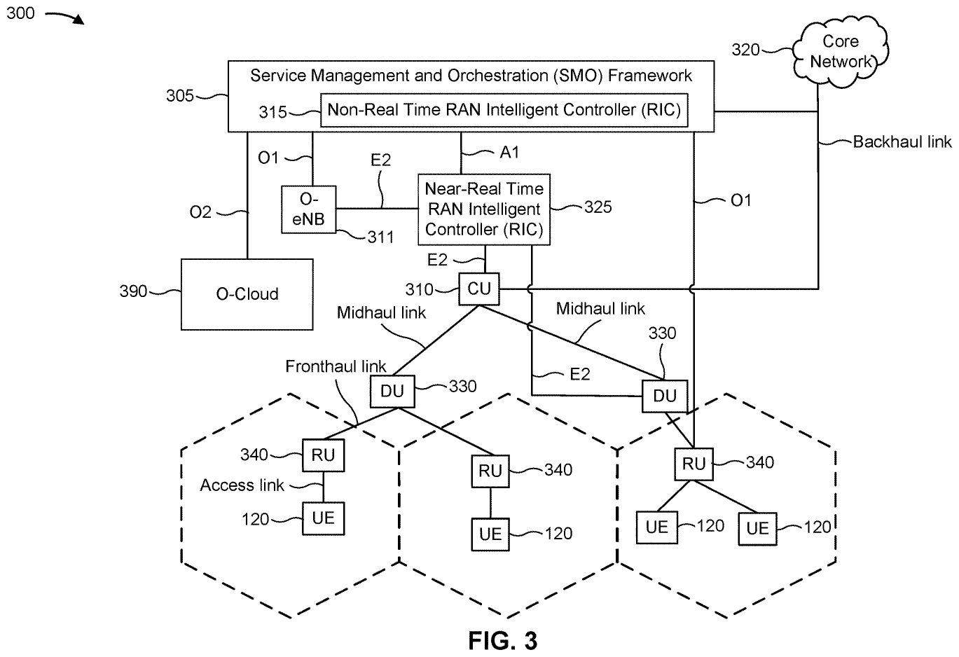

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through Fl interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

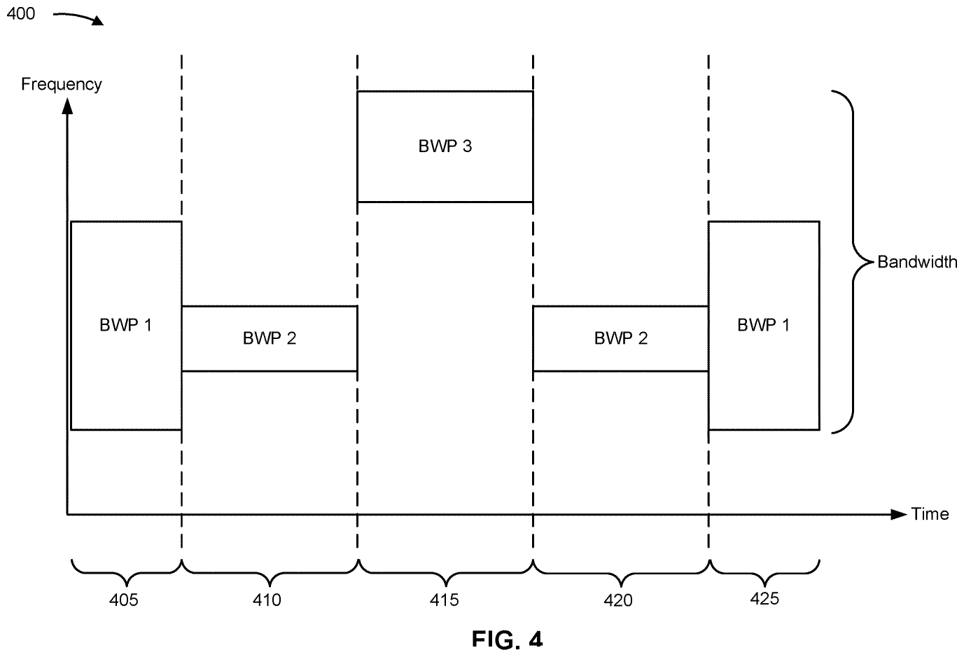

FIG. 4 is a diagram illustrating an example 400 associated with bandwidth adaptation, in accordance with the present disclosure.

To meet the growing demands for expanded mobile broadband connectivity, wireless communication technologies are advancing. For example, NR may be associated with a wider bandwidth (BW) at higher frequencies than other radio access technologies. In addition, the concept of BWPs may be introduced, where a network node may dynamically configure a UE to communicate over a portion of a wireless network system bandwidth instead of over the entire wireless network system bandwidth. The use of BWPs can provide several benefits, such as reducing UE bandwidth capability and monitoring requirements, reducing power consumptions at UEs, reducing signaling overheads, and/or allowing for load balancing within a component carrier (CC). For example, a single CC may include multiple BWPs.

A BWP is a portion of a total bandwidth configured for a communication channel. For example, a subset of a total cell bandwidth may be referred to as a BWP. For example, a BWP may be a contiguous set of physical resource blocks, selected from a continuous or contiguous subset of the common resource blocks for a given numerology on a given carrier. In some examples, only one downlink BWP and one uplink BWP can be active at a given time in one serving cell. Configured BWPs may not be larger than a maximum bandwidth supported by a UE. A UE may not be expected to receive or transmit signals outside an active BWP (e.g., except for inter-frequency measurement gaps configured by a network node). The active BWP may be a BWP that is currently being monitored by a UE. There may be different types of BWPs, such as an initial BWP (e.g., common to all UEs in a cell and is broadcasted in System Information (SI) to be used for initial access, until a UE receives a BWP cell configuration), a first active BWP (e.g., a BWP activated upon RRC (re)configuration or MAC activation of an SCell), a default BWP (e.g., a BWP activated upon the expiration of a BWP inactivity timer; the default BWP can occupy the same physical resource blocks as the initial BWP, and UEs may be expected to use the default BWP until traffic demands increase), and/or a dedicated BWP (e.g., a regular BWP configured in a dedicated manner for a given UE), among other examples.

A BWP may be associated with a given use or application. For example, the use of BWPs may enable a network node to separate and manage different types of data traffic within a wireless network, enabling an efficient and effective use of the total channel bandwidth. A BWP can be assigned or configured for a UE on a permanent or temporary basis and can be set to specific bandwidth limits to ensure that important data traffic has sufficient resources, while less critical traffic is limited to prevent congestion.

For example, with bandwidth adaptation, a receive and transmit bandwidth of a UE need not be as large as the bandwidth of the cell and can be adjusted over time. For example, a width or size of a monitored bandwidth (e.g., a monitored BWP) can be ordered or configured to change over time (e.g., to shrink during periods of low activity to save power). Additionally, or alternatively, a location of the monitored bandwidth (e.g., a monitored BWP) can move in the frequency domain (e.g., to increase scheduling flexibility). Additionally, or alternatively, a subcarrier spacing of the monitored bandwidth (e.g., a monitored BWP) can be ordered or configured to change (e.g., to allow different services). Bandwidth adaptation may be achieved by a network node configuring the UE with one or more BWPs and indicating to the UE which of the configured BWPs is currently the active BWP. The UE may monitor the active BWP (e.g., using frequency domain resources and/or other configuration parameters of the active BWP). The network node may indicate (e.g., dynamically) to the UE to switch the active BWP to another BWP so that the UE may adapt a monitored bandwidth over time. For example, the UE may support identifying a BWP identifier (ID) in a communication from a network node, such as a downlink control information (DCI) communication. BWP ID support is a feature in NR to enable varying monitored bandwidths by the UE within a larger channel bandwidth that is deployed and available (e.g., for dynamic throughput use cases for the given UE). For example, to save power for the UE as well as to accommodate UEs with different capabilities, different BWP IDs may be configured by a network node, which can be dynamically assigned to different UEs based on a data pattern, network resource availability and utilization, and/or UE capabilities, among other examples.

For example, before the introduction of BWPs, a UE may be configured to monitor and/or communicate via different bandwidths by being configured with different CCs or secondary cells (SCells). For example, a network node may add or remove CCs and/or SCells for a UE to change the bandwidth monitored by the UE. However, the process of adding a CC and/or an SCell is time consuming and is associated with significant signalling overhead to configure a new CC and/or SCell. Therefore, the feature of BWPs was introduced to enable a network node to dynamically change a portion of a channel bandwidth (e.g., a BWP) that is monitored by a UE at a given time.

For example, as shown in FIG. 4, a UE may be configured with three BWPs (e.g., shown as BWP 1, BWP 2, and BWP 3). Each BWP may be associated with one or more different parameters, such as different sizes (e.g., different frequency sizes or different quantities of resource blocks or resource elements), different subcarrier spacings, and/or different supported features, among other examples. For example, the BWP 1 may be associated with a first frequency domain size and a first subcarrier spacing, the BWP 2 may be associated with a second frequency domain size and a second subcarrier spacing, and the BWP 3 may be associated with a third frequency domain size and a third subcarrier spacing. For example, each BWP may be configured with a frequency domain location and a bandwidth (e.g., a size in terms of frequency domain resources) of that BWP (e.g., via a locationAndBandwidth RRC information element). In some examples, BWPs may share some common configuration parameters. For example, the first subcarrier spacing (e.g., configured for the BWP 1) may be the same as the second subcarrier spacing (e.g., configured for the BWP 2).

The UE may monitor different BWPs over time. For example, the UE may be configured with multiple BWPs. At a given time, the UE may only monitor a subset (e.g., one or more) of the multiple BWPs. The monitored BWP at a given time may be referred to as an active BWP. For example, the UE may receive, and a network node may transmit, an indication of an active BWP from the multiple configured BWPs. The UE may monitor the active BWP until the UE receives an indication to switch the active BWP or based on detecting little or no activity on the current active BWP. For example, the UE may be configured with an inactivity timer (e.g., a bwp-InactivityTimer) that indicates a duration (e.g., an amount of time) after which the UE falls back to (e.g., switches to) a default BWP. The default BWP may be configured for the UE and may be a BWP that the UE and/or network node automatically switches to when there is no activity in a current BWP for a duration indicated by the bwp-InactivityTimer.

For example, during a time period 405, the UE may monitor the BWP 1. For example, the BWP 1 may be the default BWP or an initial BWP (e.g., as indicated via a configuration from the network node). For example, during the time period 405, the BWP 1 may be the active BWP for the UE. The UE may monitor frequency domain resources associated with the BWP 1 during the time period 405. For example, the UE may filter out (e.g., via bandpass filtering) and/or reject signals or communications that are received via frequency domain resources outside of the BWP 1 and/or signals or communications that are indicated as being associated with a different BWP, such as the BWP 2 or the BWP 3. During a time period 410, the UE may monitor the BWP 2. For example, the UE may receive, and the network node may transmit, an indication to switch the active BWP for the UE from the BWP 1 to the BWP 2. During the time period 410, the UE may monitor frequency domain resources associated with the BWP 2. For example, the UE may filter out (e.g., via bandpass filtering) and/or reject signals or communications that are received via frequency domain resources outside of the BWP 2 and/or signals or communications that are indicated as being associated with a different BWP, such as the BWP 1 or the BWP 3.

During a time period 415, the UE may monitor the BWP 3. For example, the UE may receive, and the network node may transmit, an indication to switch the active BWP for the UE from the BWP 2 to the BWP 3. During the time period 415, the UE may monitor frequency domain resources associated with the BWP 3, in a similar manner as described elsewhere herein. As shown in FIG. 4, during a time period 420, the active BWP for the UE may be switched to the BWP 2. Similarly, during a time period 425, the active BWP for the UE may be switched to the BWP 1. Therefore, over time, the UE may monitor different BWPs associated with different parameters.

However, in some cases, the UE and the network node may be unsynchronized (e.g., out-of-sync) as to which BWP should be currently monitored by the UE (e.g., which BWP is the active BWP for the UE). For example, the UE may receive and decode a communication indicating that an active BWP is to be switched from the BWP 1 to the BWP 2. However, the communication may not be intended for the UE. For example, the UE may decode the communication to determine whether the communication is intended for the UE (e.g., via a cyclic redundancy check (CRC) operation or another operation). The UE may mistakenly identify that the communication is intended for the UE. Therefore, the UE may switch the active BWP of the UE from the BWP 1 to the BWP 2. The network node may be unaware that the UE received and decoded the communication (and switched the active BWP). The network node 110 may attempt to communicate with the UE via the BWP 1 because that is the active BWP for the UE as determined by the network node. Because the UE has switched the active BWP to the BWP 2, the UE may discard or reject communications received via the BWP 1.

As another example, the UE may prioritize other procedures or operations that cause the UE to miss or discard an active BWP switch indication (e.g., DCI). For example, the other procedures or operations may be associated with a high priority. For example, the other procedures or operations may include an antenna switching operation, an RRC reconfiguration processing operation, and/or dual connectivity or dual subscriber operations, among other examples. As a result, the UE may not receive or decode DCI indicating a BWP switch and/or may not receive or decode retransmissions of the DCI. Therefore, the UE may remain on a previous active BWP while the network node may switch the active BWP for the UE to a new active BWP, resulting in the UE and the network node being out-of-sync.

As a result, the UE may not receive scheduling grants, control information, and/or data that is transmitted by the network node via the BWP 1. For example, the UE may have uplink data to transmit (e.g., in a buffer of the UE). However, because the UE may not receive a scheduling grant via the active BWP being monitored by the UE (e.g., the BWP 2), the UE may be unable to transmit the data. As a result, the data may be discarded and/or lost by the UE due to the expiration of one or more timers (e.g., a PDCP discard timer, a packet delay budget, or another timer). The expiration of the one or more timers may occur before an expiration of an inactivity timer associated with the BWP 2. For example, the UE may experience a data stall because of the mismatch between the active BWP that the network node associates with the UE (e.g., the BWP 1) and the active BWP being monitored by the UE (e.g., the BWP 2). This may result in lost data, increased latency, and reduced performance of the UE, among other examples. For example, in some cases, if a UE detects a data stall (e.g., due to lost data, as described above), the UE may perform one or more operations to recover the data stall, such as resetting a modem of the UE, among other examples, that increase latency, consume power of the UE, and/or result in a poor user experience, among other examples.

Some techniques and apparatuses described herein enable a quick and efficient data stall recovery associated with BWP switching. For example, a UE may be enabled to detect (e.g., autonomously) that the UE and a network node are out-of-sync with respect to the active BWP for the UE. The UE may perform one or more actions to cause the UE and the network node to be re-synchronized with respect to the active BWP of the UE. For example, the UE may receive, and a network node may transmit, an indication that an active BWP is to be switched from a first BWP to a second BWP (e.g., the indication may not actually be intended for the UE). The UE may switch the active BWP for the UE to the second BWP and may monitor the second BWP. The UE may detect a trigger event associated with activity associated with at least one of the first BWP or the second BWP. For example, the UE may autonomously detect that the second BWP should not be the active BWP for the UE. The UE may switch the active BWP from the second BWP to the first BWP (e.g., the previous active BWP before switching the active BWP to the second BWP) based on, in association with, or responsive to, detecting the trigger event. The UE may monitor the first BWP and/or receive one or more communications via the first BWP.

As a result, the UE is enabled to quickly detect that the UE has incorrectly switched to a new active BWP. By switching back to the previous active BWP before switching the active BWP to the second BWP, the UE may quickly recover and/or switch to the correct active BWP for the UE, thereby ensuring that the UE and the network node are quickly re-synchronized with respect to the active BWP of the UE. This improves a likelihood that the UE is able to receive scheduling grants via the active BWP being monitored by the UE, thereby enabling the UE to transmit and/or receive data. Additionally, a likelihood that data is discarded and/or lost by the UE due to the switch to the incorrect active BWP is reduced (e.g., a PDCP discard timer, a packet delay budget, or another timer may not expire before the UE switches back to the correct active BWP as described in more detail elsewhere herein). For example, a likelihood that the UE experiences a data stall because of the mismatch between the active BWP that the network node associates with the UE (e.g., the BWP 1) and the active BWP being monitored by the UE (e.g., the BWP 2) is reduced. This reduces a likelihood of lost data, reduces latency, and/or improves performance of the UE, among other examples, in scenarios where the UE incorrectly switches the active BWP because of a reception of DCI indicating the switch (e.g., where the DCI is not actually intended for the UE).

As indicated above, FIG. 4 is provided as an example. Other examples may differ from what is described with regard to FIG. 4.

FIG. 5 is a diagram of an example 500 associated with a data stall recovery associated with BWP switching, in accordance with the present disclosure. As shown in FIG. 5, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 5.

As shown by reference number 505, the network node 110 may transmit, and the UE 120 may receive, configuration information. In some aspects, the UE 120 may receive the configuration information via one or more of system information signaling, RRC signaling, one or more MAC control elements (MAC-CEs), and/or DCI, among other examples. In some aspects, the configuration information may include an indication of one or more configuration parameters for selection by the UE 120, and/or explicit configuration information for the UE 120 to use to configure itself, among other examples.

In some aspects, the configuration information may include a BWP configuration. The BWP configuration may be included in a serving cell configuration (e.g., a ServingCellConfig). For example, the configuration information may configure a carrier bandwidth or a channel bandwidth. The BWP configuration may indicate configurations for one or more BWPs within the carrier bandwidth or the channel bandwidth. For example, the BWP configuration may indicate configurations for a default BWP, an initial BWP, a first active BWP (e.g., a first active downlink BWP, and/or a first active uplink BWP), and/or one or more dedicated BWPs for the UE 120, among other examples. For example, the BWP configuration may indicate one or more (e.g., up to four) downlink BWPs and one or more (e.g., up to four) uplink BWPs. In some aspects, the BWP configuration may indicate a configuration of an inactivity timer (e.g., the bwp-InactivityTimer) associated with triggering a fall back to the default BWP after a period of no activity on a current active BWP.

The UE 120 may configure itself based at least in part on the configuration information. In some aspects, the UE 120 may be configured to perform one or more operations described herein based at least in part on the configuration information.

As shown by reference number 510, the UE 120 may monitor a first BWP. In some aspects, the first BWP may be a downlink BWP. In some aspects, the first BWP may be an initial BWP (e.g., an initial downlink BWP), a default BWP, or another BWP indicated by the BWP configuration. For example, the network node 110 may transmit, and the UE 120 may receive, DCI indicating that the active BWP for the UE 120 is the first BWP.

As used herein, “monitoring” a BWP may refer to the UE 120 monitoring frequency domain resources (e.g., physical resource blocks) associated with the BWP for wireless signals. For example, the first BWP may be an active BWP for the UE 120. The UE may not be expected to receive signals outside of the active BWP (e.g., that are associated with frequency domain resources outside of the active BWP). In some cases, frequency domain resources of BWPs may at least partially overlap, such that the UE 120 may receive and/or decode a signal associated with another BWP in frequency domain resources of the other BWP that overlap with the active BWP. In such examples, the UE 120 may decode the signal and may determine that the signal is associated with the other BWP (e.g., based on a BWP identifier associated with a physical downlink control channel (PDCCH) that is associated with the signal). The UE 120 may discard or reject the signal based on, or associated with, the signal being associated with a BWP other than the active BWP.

In some aspects, the UE 120 may detect that the UE 120 has uplink traffic to transmit. For example, the uplink traffic may arrive at a buffer of the UE 120. Therefore, the UE 120 may transmit, and the network node 110 may receive, an indication that the UE 120 has the uplink traffic to transmit. For example, the indication may be included in a scheduling request (SR) and/or a buffer status report, among other examples. The UE 120 may monitor the first BWP (e.g., the active BWP) for a scheduling grant associated with granting resources for the UE 120 to transmit the uplink traffic.

As shown by reference number 515, the network node 110 may transmit, and the UE 120 may receive, an indication to switch the active BWP to a second BWP. For example, the network node 110 may transmit, and the UE 120 may receive, DCI indicating that the active BWP is to be switched from the first BWP to the second BWP. For example, the DCI may be transmitted via the first BWP (e.g., via a PDCCH). However, the DCI may not be intended for the UE 120. For example, the network node 110 may transmit the DCI for another UE (e.g., other than the UE 120) intending to cause the other UE to switch the active BWP of the other UE to the second BWP. For example, the UE 120 may decode the DCI to determine whether the DCI is intended for the UE 120 (e.g., via a CRC operation or another operation) because the DCI is received by the UE 120 via the first BWP. However, the UE 120 may mistakenly determine that the DCI is intended for the UE 120. Such DCI may be referred to as “ghost” DCI. As a result, an application processor (AP) of the UE 120 may instruct a modem of the UE 120 to switch the active BWP to the second BWP (e.g., based on mistakenly determining that the DCI is intended for the UE 120).

For example, as shown by reference number 520, the UE 120 may switch the active BWP of the UE 120 to the second BWP. For example, the UE 120 may switch the active BWP to the second BWP based on, associated with, or in response to, receiving the DCI (e.g., the ghost DCI) indicating that the active BWP is to be switched to the second BWP. As shown by reference number 525, the UE 120 may monitor the second BWP. For example, the UE 120 may monitor the second BWP based on, associated with, or in response to, receiving the DCI (e.g., the ghost DCI) indicating that the active BWP is to be switched to the second BWP.

The network node 110 may determine that the active BWP for the UE 120 is still the first BWP. For example, because the DCI (e.g., that caused the UE 120 to switch the active BWP to the second BWP) was not intended for the UE 120, the network node 110 may determine that the active BWP for the UE 120 is still the first BWP. Therefore, the network node 110 may attempt to communicate with the UE 120 via the first BWP. For example, as shown by reference number 530, the network node 110 may transmit one or more communications associated with the first BWP. For example, the one or more communications may be scheduling grants associated with granting resources for the UE 120 to transmit the uplink traffic. For example, the network node 110 may transmit the one or more communications during control channel (e.g., PDCCH) occasions configured for the UE 120. The one or more communications may indicate that the one or more communications are associated with the first BWP (e.g., via frequency domain resources used to transmit the one or more communications and/or via a BWP ID associated with the one or more communications).

As another example, the network node 110 may transmit an indication (e.g., via DCI) that the UE 120 is to switch an active BWP to the first BWP (e.g., in an example where the UE 120 is already monitoring the second BWP). However, for one or more reasons, the UE 120 may not receive the indication. For example, the UE 120 may drop or discard the indication and/or retransmissions of the indication due to ongoing high priority operations or procedures, such as an antenna switching procedure, and/or an RRC reconfiguration processing operation, among other examples. Therefore, the network node 110 may determine that the active BWP for the UE 120 is the first BWP, but the UE 120 may determine that the active BWP for the UE is the second BWP.

In some aspects, the UE 120 may not receive or decode the one or more communications because the UE 120 is monitoring the BWP 2 (e.g., and not the BWP 1). For example, frequency domain resources associated with the BWP 1 and the BWP 2 may not overlap in the frequency domain. In such examples, the UE 120 may not be monitoring the frequency domain resources associated with the BWP 1. Therefore, the UE 120 may not detect and/or decode the one or more communications. In other examples, there may be a frequency domain overlap between the BWP 1 and the BWP 2. In such examples, as shown by reference number 535, the UE 120 may reject or discard the one or more communications because the one or more communications are associated with the first BWP (e.g., and not the current active BWP, the second BWP, of the UE 120). For example, as described elsewhere herein, the UE 120 may not be expecting to receive signals or communications outside of the active BWP of the UE 120. Therefore, the UE 120 may discard or reject the one or more communications that are received via the first BWP.

As shown by reference number 540, the UE 120 may detect a trigger event. The trigger event may be associated with detecting that the active BWP is out-of-sync between the UE 120 and the network node 110. In some aspects, the UE 120 may autonomously detect the trigger event. For example, a modem of the UE 120 may detect the trigger event based on monitoring and/or analyzing activity associated with the first BWP and/or associated with the second BWP. For example, the trigger event may be associated with activity associated with at least one of the first BWP or the second BWP. In some aspects, the trigger event may be an internal detection at the UE 120 (e.g., may not be signaled to the UE 120 by another device). In some aspects, the activity associated with at least one of the first BWP or the second BWP may include decoding and/or signal detection information associated with the first BWP and/or the second BWP. For example, the decoding information and/or signal detection information may indicate whether (and/or how many) signals or communications are decoded and/or detected via the first BWP and/or the second BWP (e.g., over a given time period).

In some aspects, the trigger event may be associated with detecting that a number of scheduling grants received via the second BWP is less than or equal to a threshold. The threshold may be configured by the network node 110 and/or may be stored by the UE 120 (e.g., as part of an original equipment manufacturer (OEM) configuration). For example, detecting the trigger event may be based on an active BWP switch occurring and the UE 120 not receiving or detecting any scheduling PDCCH communications either for uplink or downlink on the new active BWP (e.g., the second BWP). Additionally, or alternatively, detecting the trigger event may be based on detecting that uplink data is available to be transmitted, and detecting an error associated with a procedure associated with transmitting the uplink data (e.g., via the second BWP). For example, the error may be a random access channel (RACH) procedure error and/or an error associated with an SR operation, among other examples. For example, detecting the trigger event may be based on uplink data being pending, while an SR procedure is ongoing and/or a RACH failure is happening on the new active BWP (e.g., the second BWP). Additionally, or alternatively, detecting the trigger event may be based on rejecting, in association with the active BWP being the second BWP, one or more communications associated with the first BWP (e.g., as described above in connection with reference number 535). For example, detecting the trigger event may be based on PDCCH based grants being received via the previous BWP (e.g., the first BWP) and UE 120 rejecting the PDCCH based grants because the first BWP is not the active BWP at this time.

In some aspects, the UE 120 may detect that the UE 120 and the network node 110 are out-of-sync with respect to the active BWP for the UE 120 based on, associated with, or in response to detecting: 1) an active BWP switch occurring and the UE 120 not receiving or detecting any scheduling PDCCH communications either for uplink or downlink on the new active BWP (e.g., the second BWP); 2) uplink data being pending while an SR procedure is ongoing and/or a RACH failure is happening on the new active BWP (e.g., the second BWP); and 3) PDCCH based grants being received via the previous BWP (e.g., the first BWP) and UE 120 rejecting the PDCCH based grants because the first BWP is not the active BWP at this time. If one or more (or all) of the conditions described above are met, then the UE 120 may determine that the UE 120 and the network node 110 are out-of-sync with respect to the active BWP for the UE 120. In some aspects, detecting that one or more (or all) of the conditions described above are met may cause the UE 120 to track and/or monitor other conditions (e.g., trigger conditions) described herein associated with causing the UE 120 to autonomously switch back to the previous BWP (e.g., the first BWP).

In some aspects, the trigger event may be associated with a time window (e.g., T_{duration}) during which the activity occurs after switching the active BWP from the first BWP to the second BWP. T_{duration} may be associated with an amount of time. For example, T_{duration} may be associated with a sliding time window. In other examples, a start of the T_{duration} may occur when the UE 120 switches the active BWP to the second BWP. As another example, a start of the T_{duration} may occur when the UE 120 determines that the UE 120 and the network node 110 are out-of-sync with respect to the active BWP for the UE 120 (e.g., in a similar manner as described above).

For example, detecting the trigger event may include detecting that, during the time window T_{duration}, uplink traffic is available to be communicated and that no uplink grants (e.g., PDCCH grants) have been received via the second BWP (e.g., the current active BWP). For example, the UE 120 may detect that in a last T_{duration} there have been no PDCCH grants decoded on the second BWP (e.g., the current active BWP of the UE 120). Additionally, or alternatively, the UE 120 may detect that, during the time window T_{duration}, one or more communications that are associated with the first BWP have been discarded or rejected associated with, or based on, the active BWP being the second BWP (e.g., in a similar manner as described above in connection with reference number 535). In some aspects, the UE 120 may detect that during the time window T_{duration}, a number of the one or more rejected or discarded communications satisfies a threshold. For example, the UE 120 may detect the trigger event based on, in a last T_{duration}, there having been no PDCCH grants decoded on the second BWP (or a quantity of the PDCCH grants decoded by the UE 120 on the second BWP is less than a grant threshold) and that there has been a rejection or discard of PDCCH grants occurring associated with the first BWP (e.g., the previous or most recent active BWP).

Additionally, or alternatively, the trigger event may be associated with a quantity of occasions (e.g., control channel occasions, PDCCH occasions, and/or reception occasions) during which trigger conditions are detected satisfying a discard threshold (e.g., N). As used herein, an “occasion” may refer to radio resources (e.g., time domain resources, frequency domain resources, spatial domain resources, and/or code domain resources) that are configured or scheduled to be available for the UE 120 to transmit or receive communications. For example, a PDCCH configuration may indicate one or more occasions during which the UE 120 may receive PDCCH communications. For example, detecting the trigger event may be based on detecting that a number of control channel occasions (e.g., PDCCH occasions) in which one or more communications associated with the first BWP that have been discarded or rejected, associated with the active BWP being the second BWP, satisfies the discard threshold (e.g., N). Additionally, or alternatively, detecting the trigger event may be based on detecting that no uplink grants have been decoded or received via the second BWP during a last N control channel occasions.

For example, the UE 120 may maintain a discard counter associated with tracking the number of control channel occasions associated with discarding or rejecting communications from BWPs other than the active BWP (e.g., the second BWP). For example, the UE 120 may reset the discard counter associated with receiving or decoding the communication via the second BWP (e.g., the current active BWP). The UE 120 may detect the trigger event based on detecting that a value of the counter satisfies the discard threshold (e.g., N). In other words, the UE 120 may detect the trigger event based on detecting that in a last N occasions (e.g., control channel occasions or PDCCH occasions), a grant associated with the first BWP is rejected or discarded and that no grants associated with the second BWP (e.g., the active BWP) are decoded.

In some aspects, an amount of time associated with the time window T_{duration}, and/or a value associated with the discard threshold (e.g., N) may be configured by the network node 110. In other aspects, the amount of time associated with the time window T_{duration}, and/or the value associated with the discard threshold (e.g., N) may be determined by the UE 120. In some aspects, the amount of time associated with the time window T_{duration}, and/or the value associated with the discard threshold (e.g., N) may be stored by the UE 120. In some aspects, the amount of time associated with the time window T_{duration}, and/or the value associated with the discard threshold (e.g., N) may be based on, or associated with, radio conditions associated with the first BWP and/or the second BWP, information associated with a radio access technology being used by the UE 120, and/or the BWP configuration, among other examples.

For example, the amount of time associated with the time window T_{duration}, and/or the value associated with the discard threshold (e.g., N) may be based on, or associated with, a resource block allocation associated with the first BWP and/or the second BWP, a pathloss value associated with the first BWP and/or the second BWP, an RSRP associated with the first BWP and/or the second BWP, bit decode error information (e.g., errors associated with a CRC operation), and/or feedback error information associated with the first BWP and/or the second BWP, among other examples. Additionally, or alternatively, the amount of time associated with the time window T_{duration}, and/or the value associated with the discard threshold (e.g., N) may be based on, or associated with, a radio access technology type, a subcarrier spacing, a frequency band, and/or a frequency range, among other examples, being used by the UE 120 to communicate with the network node 110. Additionally, or alternatively, the amount of time associated with the time window T_{duration}, and/or the value associated with the discard threshold (e.g., N) may be based on, or associated with, a number of configured BWPs, and/or an inactivity timer, among other examples, indicated by the BWP configuration.

In some aspects, the time window may be associated with an amount of time during which no grants or PDCCH communications are received via the second BWP while the UE 120 has uplink traffic to transmit. For example, detecting the trigger event may be based on, or associated with, detecting that the UE 120 has transmitted, to the network node 110, an indication that the UE 120 has the uplink traffic to transmit (e.g., via an SR or a buffer status report) and that no grants are received via the second BWP (e.g., the active BWP) for x milliseconds after a grant (e.g., a DCI) is rejected or discarded by the UE 120 (e.g., because the grant is associated with the first BWP and/or for other reasons, such as an ongoing conflicting operation). In some aspects, the time window may be associated with an amount of time during which no grants or PDCCH communications are received via the second BWP. For example detecting the trigger event may be based on, or associated with, detecting that an amount of time from receiving the indication to switching the active BWP to the second BWP during which no downlink or uplink grants have been received via the second BWP satisfies a time threshold (e.g., y milliseconds). In other words, detecting the trigger event may be based on, or associated with, detecting that no downlink or uplink grants have been received via the second BWP for y milliseconds after receiving the indication to switch the active BWP to the second BWP. For example, an amount of time of the T_{duration} may be the x milliseconds and/or the y milliseconds.

The UE 120 may perform one or more operations to re-sync the active BWP between the UE 120 and the network node 110 based on, in association with, or in response to detecting the trigger event. For example, as shown by reference number 545, the UE 120 may switch the active BWP from the second BWP to the first BWP (e.g., the most recent or previous active BWP before the active BWP was switched to the second BWP) based on, in association with, or in response to detecting the trigger event. For example, the UE 120 may initiate an inactivity timer that is associated with a fall back to a previous BWP. The inactivity timer may be different than the inactivity timer that is associated with the fall back to the default BWP (e.g., the bwp-InactivityTimer). For example, when the inactivity timer expires, the UE 120 may switch the active BWP to a previous active BWP (e.g., rather than to the default BWP). For example, the UE 120 may initiate the inactivity timer based on detecting the trigger event. The switch of the active BWP from the second BWP to the first BWP may be associated with, based on, or in response to, an expiry of the inactivity timer. An amount of the inactivity timer may be indicated by the network node 110 (e.g., in the BWP configuration), determined by the UE 120, and/or stored by the UE 120 (e.g., as part of an OEM configuration). In some aspects, an amount of the inactivity timer may be defined, or otherwise fixed, by a wireless communication standard, such as the 3GPP. In some aspects, the amount of the inactivity timer may be the same as the amount of time of the bwp-InactivityTimer configured via the BWP configuration.

Additionally, or alternatively, the UE 120 may monitor a bandwidth that is wider than the second bandwidth (e.g., a channel bandwidth or a carrier bandwidth) based on, in association with, or in response to detecting the trigger event. In some aspects, the wider bandwidth may be a BWP associated with frequency domain resources that at least include frequency domain resources of the first BWP and frequency domain resources of the second BWP. In some aspects, the wider bandwidth may be a full channel bandwidth and/or a full carrier bandwidth. For example, the UE 120 may switch the monitored bandwidth to the full channel bandwidth of the full carrier bandwidth. The UE 120 may receive, detect, and/or decode one or more communications associated with the first BWP based on monitoring the full channel bandwidth of the full carrier bandwidth. For example, the UE 120 may monitor the full channel bandwidth of the full carrier bandwidth to detect in which BWP, from multiple configured BWPs, the network node 110 is currently transmitting communications for the UE 120. The UE 120 may detect one or more communications associated with the first BWP based on monitoring the full channel bandwidth of the full carrier bandwidth. Therefore, the UE 120 may switch the active BWP to the first BWP. In other words, the switching of the active BWP from the second BWP to the first BWP is associated with the reception of the one or more communications associated with the first BWP.

In some aspects, the UE 120 may transmit via the first BWP, and associated with detecting the trigger event, a scheduling request after switching of the active BWP from the second BWP to the first BWP. For example, the UE 120 may transmit a probing SR after falling back to the previous BWP (e.g., the first BWP) if a previously transmitted SR is no longer valid (e.g., to indicate to the network node 110 that the UE 120 has uplink traffic to transmit).

As shown by reference number 550, the UE 120 may monitor the first BWP based on, in association with, or in response to switching (e.g., autonomously) the active BWP back to the first BWP. For example, based on detecting the trigger event, the UE 120 may autonomously (e.g., without receiving instructions or explicit signaling from the network node 110) switch the active BWP to the first BWP and monitor the first BWP for communications. For example, as shown by reference number 555, the UE 120 may receive one or more communications associated with the first BWP (e.g., based on monitoring the first BWP). For example, the one or more communications may include grants (e.g., DCI) indicating resources to be used by the UE 120 to transmit the uplink traffic pending at the UE 120.

As a result, the UE 120 is enabled to quickly detect that the UE 120 has incorrectly switched to a new active BWP. By switching back to the previous active BWP before switching the active BWP to the second BWP, the UE 120 may quickly recover and/or switch to the correct active BWP for the UE 120, thereby ensuring that the UE 120 and the network node 110 are quickly re-synchronized with respect to the active BWP of the UE 120. This improves a likelihood that the UE 120 is able to receive scheduling grants via the active BWP being monitored by the UE 120, thereby enabling the UE to transmit and/or receive data. Additionally, a likelihood that data is discarded and/or lost by the UE 120 due to the switch to the incorrect active BWP is reduced (e.g., a PDCP discard timer, a packet delay budget, or another timer may not expire before the UE 120 switches back to the correct active BWP as described in more detail elsewhere herein). For example, a likelihood that the UE 120 experiences a data stall because of the mismatch between the active BWP that the network node associates with the UE 120 (e.g., the first BWP) and the active BWP being monitored by the UE (e.g., the second BWP) is reduced. This reduces a likelihood of lost data, reduces latency, and/or improves performance of the UE 120, among other examples, in scenarios where the UE incorrectly switches the active BWP because of a reception of DCI indicating the switch (e.g., where the DCI is not actually intended for the UE 120).

As indicated above, FIG. 5 is provided as an example. Other examples may differ from what is described with respect to FIG. 5.

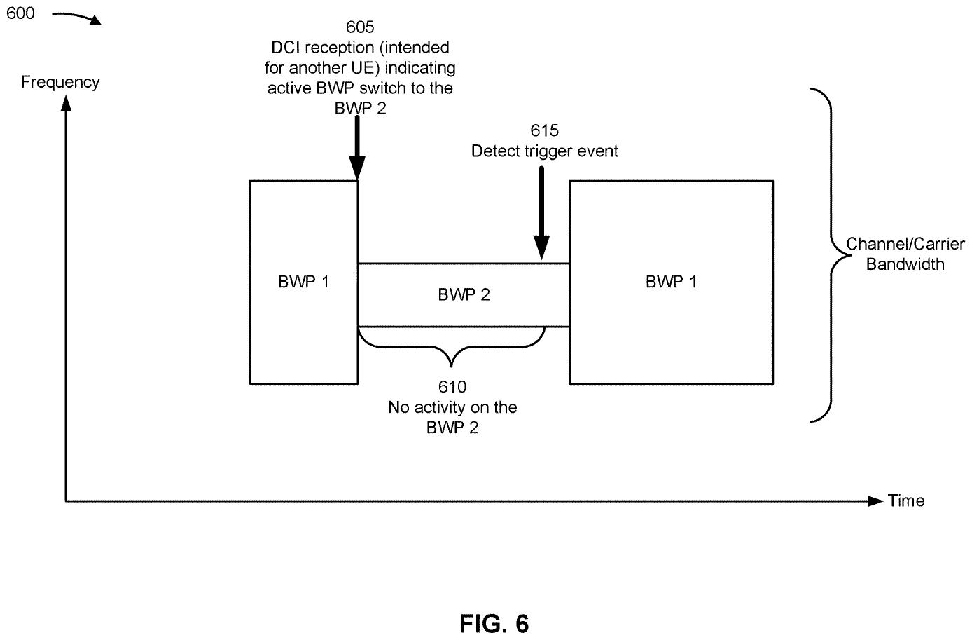

FIG. 6 is a diagram of an example 600 associated with a data stall recovery associated with BWP switching, in accordance with the present disclosure. As shown in FIG. 6, a UE 120 may be configured with a first BWP (e.g., BWP 1) and a second BWP (e.g., BWP 2) in a similar manner as described elsewhere herein. For example, the BWP 1 may be the active BWP for the UE 120 at a first time.

As shown by reference number 605, the UE 120 may receive DCI indicating that the active BWP is to be switched to the BWP 2. However, the DCI may not actually be intended for the UE 120 and the UE 120 may incorrectly determine that the DCI was intended for the UE 120, as described in more detail elsewhere herein. As a result, the UE 120 may switch the active BWP to the BWP 2 in response to receiving the DCI.

As shown by reference number 610, the UE 120 may detect little or no activity on the BWP 2 because the BWP 2 is not the active BWP for the UE 120 as determined by the network node 110; therefore, the network node 110 may not be using the BWP 2 to communicate with the UE 120. As shown by reference number 615, the UE 120 may detect a trigger event associated with autonomously switching, or falling back, the active BWP to the BWP 1, as described in more detail elsewhere herein. For example, the trigger event may be associated with a lack of activity on the BWP 2 and/or activity occurring on the BWP 1 (e.g., the network node 110 may be attempting to communicate with the UE 120 via the BWP 1, but the UE 120 may be rejecting or discarding the communications due to the active BWP at the UE 120 being the BWP 2). As shown in FIG. 6, in response to detecting the trigger event, the UE 120 may cause the active BWP to be switched back to the BWP 1 (e.g., autonomously, without receiving explicit instructions from the network node 110 to do so). As a result, the UE 120 and the network node 110 may be re-synchronized with respect to the active BWP, enabling the UE 120 and the network node 110 to quickly resume communications via the BWP 1.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., the UE 120) performs operations associated with techniques for data stall recovery associated with BWP switching.

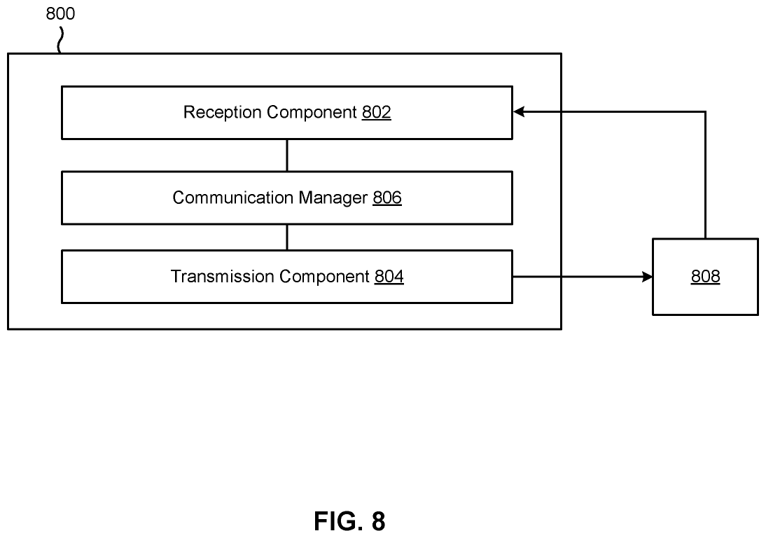

As shown in FIG. 7, in some aspects, process 700 may optionally include receiving downlink control information indicating that an active BWP is to be switched from a first BWP to a second BWP (block 710). For example, the UE (e.g., using reception component 802 and/or communication manager 806, depicted in FIG. 8) may receive downlink control information indicating that an active BWP is to be switched from a first BWP to a second BWP, as described above.

As further shown in FIG. 7, in some aspects, process 700 may include monitoring the second BWP associated with receiving the downlink control information indicating that the active BWP is to be switched to the second BWP (block 720). For example, the UE (e.g., using communication manager 806, depicted in FIG. 8) may monitor the second BWP associated with receiving the downlink control information indicating that the active BWP is to be switched to the second BWP, as described above.

As further shown in FIG. 7, in some aspects, process 700 may include detecting a trigger event associated with activity associated with at least one of the first BWP or the second BWP (block 730). For example, the UE (e.g., using communication manager 806, depicted in FIG. 8) may detect a trigger event associated with activity associated with at least one of the first BWP or the second BWP, as described above.

As further shown in FIG. 7, in some aspects, process 700 may include switching, in association with detecting the trigger event, the active BWP from the second BWP to the first BWP (block 740). For example, the UE (e.g., using communication manager 806, depicted in FIG. 8) may switch, in association with detecting the trigger event, the active BWP from the second BWP to the first BWP, as described above.

As further shown in FIG. 7, in some aspects, process 700 may include monitoring, in association with switching the active BWP, the first BWP (block 750). For example, the UE (e.g., using communication manager 806, depicted in FIG. 8) may monitor, in association with switching the active BWP, the first BWP, as described above.

Process 700 may include additional aspects, such as any single aspect or any combination of aspects described below and/or in connection with one or more other processes described elsewhere herein.

In a first aspect, process 700 includes receiving, in association with monitoring the first BWP, one or more communications using frequency domain resources associated with the first BWP.

In a second aspect, alone or in combination with the first aspect, detecting the trigger event includes detecting that a number of scheduling grants received via the second BWP is less than or equal to a threshold.

In a third aspect, alone or in combination with one or more of the first and second aspects, detecting the trigger event includes detecting that uplink data is available to be transmitted, and detecting an error associated with a procedure associated with transmitting the uplink data, the procedure being associated with the second BWP.

In a fourth aspect, alone or in combination with one or more of the first through third aspects, detecting the trigger event includes rejecting, associated with the active BWP being the second BWP, one or more communications associated with the first BWP.

In a fifth aspect, alone or in combination with one or more of the first through fourth aspects, the trigger event is associated with a time window during which the activity occurs after switching the active BWP from the first BWP to the second BWP.

In a sixth aspect, alone or in combination with one or more of the first through fifth aspects, detecting the trigger event includes detecting that, during the time window, uplink traffic is available to be communicated and that no uplink grants have been received via the second BWP.

In a seventh aspect, alone or in combination with one or more of the first through sixth aspects, detecting the trigger event includes detecting that, during the time window, one or more communications that are associated with the first BWP have been discarded or rejected associated with the active BWP being the second BWP.

In an eighth aspect, alone or in combination with one or more of the first through seventh aspects, detecting the trigger event includes detecting the trigger event associated with a number of the one or more communications satisfying a threshold.

In a ninth aspect, alone or in combination with one or more of the first through eighth aspects, an amount of time associated with the time window is associated with at least one of radio conditions associated with the first BWP or the second BWP, information associated with a radio access technology being used by the UE, or a BWP configuration.

In a tenth aspect, alone or in combination with one or more of the first through ninth aspects, the radio conditions include at least one of a resource block allocation, a pathloss value, a reference signal received power, or error information.

In an eleventh aspect, alone or in combination with one or more of the first through tenth aspects, the information associated with the radio access technology includes at least one of a radio access technology type, a subcarrier spacing, a frequency band, or a frequency range.

In a twelfth aspect, alone or in combination with one or more of the first through eleventh aspects, the BWP configuration indicates at least one of a number of configured BWPs, or an inactivity timer associated with fall back to a default BWP.

In a thirteenth aspect, alone or in combination with one or more of the first through twelfth aspects, detecting the trigger event includes detecting that a number of control channel occasions in which one or more communications associated with the first BWP that have been discarded or rejected, associated with the active BWP being the second BWP, satisfies a discard threshold.

In a fourteenth aspect, alone or in combination with one or more of the first through thirteenth aspects, detecting the trigger event includes detecting that no uplink grants have been decoded or received via the second BWP during the control channel occasions.

In a fifteenth aspect, alone or in combination with one or more of the first through fourteenth aspects, detecting that the number of control channel occasions satisfies the discard threshold includes maintaining a discard counter associated with tracking the number of control channel occasions, and detecting that a value of the discard counter satisfies the discard threshold.

In a sixteenth aspect, alone or in combination with one or more of the first through fifteenth aspects, process 700 includes receiving or decoding a communication via the second BWP, and resetting the discard counter associated with receiving or decoding the communication via the second BWP.

In a seventeenth aspect, alone or in combination with one or more of the first through sixteenth aspects, a value of the discard threshold is associated with at least one of radio conditions associated with the first BWP or the second BWP, information associated with a radio access technology being used by the UE, or a BWP configuration.

In an eighteenth aspect, alone or in combination with one or more of the first through seventeenth aspects, the radio conditions include at least one of a resource block allocation, a pathloss value, a reference signal received power, or error information.

In a nineteenth aspect, alone or in combination with one or more of the first through eighteenth aspects, the information associated with the radio access technology includes at least one of a radio access technology type, a subcarrier spacing, a frequency band, or a frequency range.

In a twentieth aspect, alone or in combination with one or more of the first through nineteenth aspects, the BWP configuration indicates at least one of a number of configured BWPs, or an inactivity timer.

In a twenty-first aspect, alone or in combination with one or more of the first through twentieth aspects, process 700 includes initiating, in association with detecting the trigger event, an inactivity timer associated with falling back to a previous BWP, where the switch of the active BWP from the second BWP to the first BWP is in association with an expiry of the inactivity timer.

In a twenty-second aspect, alone or in combination with one or more of the first through twenty-first aspects, process 700 includes transmitting, via the first BWP and associated with detecting the trigger event, a scheduling request after switching of the active BWP from the second BWP to the first BWP.

In a twenty-third aspect, alone or in combination with one or more of the first through twenty-second aspects, process 700 includes monitoring, in association with detecting the trigger event, a channel bandwidth, and receiving, in association with monitoring the channel bandwidth, one or more communications associated with the first BWP, where the switch of the active BWP from the second BWP to the first BWP is in association with the reception of the one or more communications associated with the first BWP.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5 and 6. Additionally, or alternatively, the apparatus 800 may be configured to perform one or more processes described herein, such as process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2.

Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive downlink control information indicating that an active BWP is to be switched from a first BWP to a second BWP. The communication manager 806 may monitor the second BWP associated with receiving the downlink control information indicating that the active BWP is to be switched to the second BWP. The communication manager 806 may detect a trigger event associated with activity associated with at least one of the first BWP or the second BWP. The communication manager 806 may switch, in association with detecting the trigger event, the active BWP from the second BWP to the first BWP. The communication manager 806 may monitor, in association with switching the active BWP, the first BWP.

The reception component 802 may receive, in association with monitoring the first BWP, one or more communications using frequency domain resources associated with the first BWP.

The reception component 802 may receive or decode a communication via the second BWP.

The communication manager 806 may reset the discard counter associated with receiving or decoding the communication via the second BWP.

The communication manager 806 may initiate, in association with detecting the trigger event, an inactivity timer associated with falling back to a previous BWP, wherein the switch of the active BWP from the second BWP to the first BWP is in association with an expiry of the inactivity timer.

The transmission component 804 may transmit, via the first BWP and associated with detecting the trigger event, a scheduling request after switching of the active BWP from the second BWP to the first BWP.

The communication manager 806 may monitor, in association with detecting the trigger event, a channel bandwidth.

The reception component 802 may receive, in association with monitoring the channel bandwidth, one or more communications associated with the first BWP, wherein the switch of the active BWP from the second BWP to the first BWP is in association with the reception of the one or more communications associated with the first BWP.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components.

Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving downlink control information indicating that an active bandwidth part (BWP) is to be switched from a first BWP to a second BWP; monitoring the second BWP associated with receiving the downlink control information indicating that the active BWP is to be switched to the second BWP; detecting a trigger event associated with activity associated with at least one of the first BWP or the second BWP; switching, in association with detecting the trigger event, the active BWP from the second BWP to the first BWP; and monitoring, in association with switching the active BWP, the first BWP.
Aspect 2: The method of Aspect 1, further comprising: receiving, in association with monitoring the first BWP, one or more communications using frequency domain resources associated with the first BWP.
Aspect 3: The method of any of Aspects 1-2, wherein detecting the trigger event comprises: detecting that a number of scheduling grants received via the second BWP is less than or equal to a threshold.
Aspect 4: The method of any of Aspects 1-3, wherein detecting the trigger event comprises: detecting that uplink data is available to be transmitted; and detecting an error associated with a procedure associated with transmitting the uplink data, the procedure being associated with the second BWP.
Aspect 5: The method of any of Aspects 1-4, wherein detecting the trigger event comprises: rejecting, associated with the active BWP being the second BWP, one or more communications associated with the first BWP.
Aspect 6: The method of any of Aspects 1-5, wherein the trigger event is associated with a time window during which the activity occurs after switching the active BWP from the first BWP to the second BWP.
Aspect 7: The method of Aspect 6, wherein detecting the trigger event comprises: detecting that, during the time window, uplink traffic is available to be communicated and that no uplink grants have been received via the second BWP.
Aspect 8: The method of any of Aspects 6-7, wherein detecting the trigger event comprises: detecting that, during the time window, one or more communications that are associated with the first BWP have been discarded or rejected associated with the active BWP being the second BWP.
Aspect 9: The method of Aspect 8, wherein detecting the trigger event comprises: detecting the trigger event associated with a number of the one or more communications satisfying a threshold.
Aspect 10: The method of any of Aspects 6-9, wherein an amount of time associated with the time window is associated with at least one of: radio conditions associated with the first BWP or the second BWP, information associated with a radio access technology being used by the UE, or a BWP configuration.
Aspect 11: The method of Aspect 10, wherein the radio conditions include at least one of: a resource block allocation, a pathloss value, a reference signal received power, feedback error information, or bit decode error information.
Aspect 12: The method of any of Aspects 10-11, wherein the information associated with the radio access technology includes at least one of: a radio access technology type, a subcarrier spacing, a frequency band, or a frequency range.
Aspect 13: The method of any of Aspects 10-12, wherein the BWP configuration indicates at least one of: a number of configured BWPs, or an inactivity timer associated with fall back to a default BWP.
Aspect 14: The method of any of Aspects 1-13, wherein detecting the trigger event comprises: detecting that a number of control channel occasions in which one or more communications associated with the first BWP that have been discarded or rejected, associated with the active BWP being the second BWP, satisfies a discard threshold.
Aspect 15: The method of Aspect 14, wherein detecting the trigger event comprises: detecting that no uplink grants have been decoded or received via the second BWP during the control channel occasions.
Aspect 16: The method of any of Aspects 14-15, wherein detecting that the number of control channel occasions satisfies the discard threshold comprises: maintaining a discard counter associated with tracking the number of control channel occasions; and detecting that a value of the discard counter satisfies the discard threshold.
Aspect 17: The method of Aspect 16, further comprising: receiving or decoding a communication via the second BWP; and resetting the discard counter associated with receiving or decoding the communication via the second BWP.
Aspect 18: The method of any of Aspects 14-17, wherein a value of the discard threshold is associated with at least one of: radio conditions associated with the first BWP or the second BWP, information associated with a radio access technology being used by the UE, or a BWP configuration.
Aspect 19: The method of Aspect 18, wherein the radio conditions include at least one of: a resource block allocation, a pathloss value, a reference signal received power, feedback error information, or bit decode error information.
Aspect 20: The method of any of Aspects 18-19, wherein the information associated with the radio access technology includes at least one of: a radio access technology type, a subcarrier spacing, a frequency band, or a frequency range.
Aspect 21: The method of any of Aspects 18-20, wherein the BWP configuration indicates at least one of: a number of configured BWPs, or an inactivity timer.
Aspect 22: The method of any of Aspects 1-21, further comprising: initiating, in association with detecting the trigger event, an inactivity timer associated with falling back to a previous BWP, wherein the switch of the active BWP from the second BWP to the first BWP is in association with an expiry of the inactivity timer.
Aspect 23: The method of any of Aspects 1-22, further comprising: transmitting, via the first BWP and associated with detecting the trigger event, a scheduling request after switching of the active BWP from the second BWP to the first BWP.
Aspect 24: The method of any of Aspects 1-23, further comprising: monitoring, in association with detecting the trigger event, a channel bandwidth; and receiving, in association with monitoring the channel bandwidth, one or more communications associated with the first BWP, wherein the switch of the active BWP from the second BWP to the first BWP is in association with the reception of the one or more communications associated with the first BWP.
Aspect 25: An apparatus for wireless communication at a device, comprising a processor; memory coupled with the processor; and instructions stored in the memory and executable by the processor to cause the apparatus to perform the method of one or more of Aspects 1-24.
Aspect 26: A device for wireless communication, comprising a memory and one or more processors coupled to the memory, the one or more processors configured to perform the method of one or more of Aspects 1-24.
Aspect 27: An apparatus for wireless communication, comprising at least one means for performing the method of one or more of Aspects 1-24.
Aspect 28: A non-transitory computer-readable medium storing code for wireless communication, the code comprising instructions executable by a processor to perform the method of one or more of Aspects 1-24.
Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving downlink control information indicating that an active bandwidth part (BWP) is to be switched from a first BWP to a second BWP;
monitoring the second BWP in association with receiving the downlink control information indicating that the active BWP is to be switched to the second BWP;
detecting a trigger event associated with activity on at least one of the first BWP or the second BWP;
switching, in association with detecting the trigger event, the active BWP from the second BWP to the first BWP; and
monitoring, in association with switching the active BWP, the first BWP.

2. The method of claim 1, further comprising:
receiving, in association with monitoring the first BWP, one or more communications using frequency domain resources associated with the first BWP.

3. The method of claim 1, wherein detecting the trigger event comprises:
detecting that a number of scheduling grants received via the second BWP is less than or equal to a threshold.

4. The method of claim 1, wherein detecting the trigger event comprises:
detecting that uplink data is available to be transmitted; and
detecting an error associated with a procedure associated with transmitting the uplink data, the procedure being associated with the second BWP.

5. The method of claim 1, wherein detecting the trigger event comprises:
rejecting, in association with the active BWP being the second BWP, one or more communications associated with the first BWP.

6. The method of claim 1, wherein the trigger event is associated with a time window during which the activity occurs after switching the active BWP from the first BWP to the second BWP, and wherein detecting the trigger event comprises:
detecting that, during the time window, uplink traffic is available to be communicated and that no uplink grants have been received via the second BWP.

7. The method of claim 1, wherein the trigger event is associated with a time window during which the activity occurs after switching the active BWP from the first BWP to the second BWP, and wherein detecting the trigger event comprises:
detecting that, during the time window, one or more communications that are associated with the first BWP have been discarded or rejected associated with the active BWP being the second BWP.

8. The method of claim 1, wherein the trigger event is associated with a time window during which the activity occurs after switching the active BWP from the first BWP to the second BWP, and wherein an amount of time associated with the time window is associated with at least one of:
radio conditions associated with the first BWP or the second BWP,
information associated with a radio access technology being used by the UE, or
a BWP configuration.

9. The method of claim 1, further comprising:
initiating, in association with detecting the trigger event, an inactivity timer associated with falling back to a previous BWP,
wherein the switch of the active BWP from the second BWP to the first BWP is in association with an expiry of the inactivity timer.

10. The method of claim 1, further comprising:
transmitting, via the first BWP and associated with detecting the trigger event, a scheduling request after switching of the active BWP from the second BWP to the first BWP.

11. A user equipment (UE) for wireless communication, comprising:
one or more memories; and
one or more processors, coupled to the one or more memories, configured to:
receive downlink control information indicating that an active bandwidth part (BWP) is to be switched from a first BWP to a second BWP;
monitor the second BWP in association with receiving the downlink control information indicating that the active BWP is to be switched to the second BWP;
detect a trigger event associated with activity on with at least one of the first BWP or the second BWP;
switch, in association with detecting the trigger event, the active BWP from the second BWP to the first BWP; and
monitor, in association with switching the active BWP, the first BWP.

12. The UE of claim 11, wherein the one or more processors, to detect the trigger event, are configured to:
detect that a number of scheduling grants received via the second BWP is less than or equal to a threshold.

13. The UE of claim 11, wherein the one or more processors, to detect the trigger event, are configured to:
detect that uplink data is available to be transmitted; and
detect an error associated with a procedure associated with transmitting the uplink data, the procedure being associated with the second BWP.

14. The UE of claim 11, wherein the one or more processors, to detect the trigger event, are configured to:
detect that a number of control channel occasions in which one or more communications associated with the first BWP that have been discarded or rejected, associated with the active BWP being the second BWP, satisfies a discard threshold.

15. The UE of claim 14, wherein the one or more processors, to detect the trigger event, are configured to:
detect that no uplink grants have been decoded or received via the second BWP during the control channel occasions.

16. The UE of claim 14, wherein the one or more processors, to detect that the number of control channel occasions satisfies the discard threshold, are configured to:
maintain a discard counter associated with tracking the number of control channel occasions; and
detect that a value of the discard counter satisfies the discard threshold.

17. The UE of claim 16, wherein the one or more processors are further configured to:
receive or decode a communication via the second BWP; and
reset the discard counter associated with receiving or decoding the communication via the second BWP.

18. An apparatus for wireless communication, comprising:
means for receiving downlink control information indicating that an active bandwidth part (BWP) is to be switched from a first BWP to a second BWP;
means for monitoring the second BWP in association with receiving the downlink control information indicating that the active BWP is to be switched to the second BWP;
means for detecting a trigger event associated with activity on at least one of the first BWP or the second BWP;
means for switching, in association with detecting the trigger event, the active BWP from the second BWP to the first BWP; and
means for monitoring, in association with switching the active BWP, the first BWP.

19. The apparatus of claim 18, further comprising:
means for receiving, in association with monitoring the first BWP, one or more communications using frequency domain resources associated with the first BWP.

20. The apparatus of claim 18, wherein the means for detecting the trigger event comprises:
means for detecting that a number of scheduling grants received via the second BWP is less than or equal to a threshold.
